(19) United States
(12) Patent Application Publication
(10) Pub. No.: US 2023/0281399 A1
(43) Pub. Date: Sep. 7, 2023

(54) LANGUAGE AGNOSTIC ROUTING PREDICTION FOR TEXT QUERIES

(71) Applicant: INTUIT INC., Mountain View, CA (US)

(72) Inventors: Prarit LAMBA, San Diego, CA (US); Clifford GREEN, San Diego, CA (US); Tomer TAL, Mountain View, CA (US); Andrew MATTARELLA-MICKE, Mountain View, CA (US)

(73) Assignee: INTUIT INC., Mountain View, CA (US)

(21) Appl. No.: 17/653,426

(22) Filed: Mar. 3, 2022

(51) Int. Cl. G06F 40/58; G06F 40/56; G06K 9/62

(52) U.S. Cl. CPC G06F 40/58; G06F 40/56; G06K 9/6257

(57) ABSTRACT

Embodiments disclosed herein provide language-agnostic routing prediction models. The routing prediction models input text queries in any language and generate a routing prediction for the text queries. For a language that may have sparse training text data, the models, which are machine learning models, are trained using a machine translation to a prevalent language (e.g., English) to the language having sparse training text data -with the original text corpus and the translated text corpus being an input to multi-language embedding layers. The trained machine learning model makes routing predictions for text queries for the language having sparse training text data.

### BACKGROUND

Natural language processing techniques are used for automated text query processing. For instance, in the context of a help desk that processes text-based customer queries to route the queries to one or more queues, natural language processing may be used to ascertain the meaning of each query. The meaning may include sematic or syntactic meanings of the words or a group of words in the queries. Based on these meanings, the queries may be routed to an appropriate queue.

Conventional natural language processing, however, is significantly language dependent. For instance, most conventional natural language processing models are trained to process English-language text at least because training data for non-English-language text has remained scarce. The natural language processing models trained in English, however, are not suited for processing other languages to extract even basic semantic and syntactic meanings. The challenge of extracting higher and more complex meanings from the non-English-language text-based queries increases exponentially.

### SUMMARY

Embodiments disclosed herein provide language-agnostic routing prediction models. The routing prediction models input text queries in any language and generate a routing prediction for the text queries. For a language that may have sparse training text data, the models, which are machine learning models, are trained using a machine translation to a prevalent language (e.g., English) to the language having sparse training text data -with the original text corpus and the translated text corpus being an input to multi-language embedding layers. The trained machine learning model makes routing predictions for text queries for the language having sparse training text data.

In an embodiment, a method performed by a processor is provided. The method may include translating a plurality of training text queries in a first natural language to a second natural language to generate a plurality of translated training text queries; retrieving structured contextual information corresponding to the plurality of training text queries; converting, using one or more multi-language embedding layers, the plurality of training text queries in the first natural language and the plurality of translated training text queries in the second natural language into embedding vectors; and training a machine learning model using the contextual information and the embedding vectors, the trained machine learning model is adapted to be used for generating a multi-channel routing prediction from a test text query in the second natural language.

In another embodiment, a system is provided. The system includes at least one processor; and a computer readable non-transitory storage medium storing computer program instructions that when executed by the at least one processor cause the at least one processor to perform operations comprising: translating a plurality of training text queries in a first natural language to a second natural language to generate a plurality of translated training text queries; retrieving structured contextual information corresponding to the plurality of training text queries; converting, using one or more multi-language embedding layers, the plurality of training text queries in the first natural language and the plurality of translated training text queries in the second natural language into embedding vectors; and training a machine learning model using the contextual information and the embedding vectors, the trained machine learning model is adapted to be used for generating a multi-channel routing prediction from a test text query in the second natural language.

In yet another embodiment, method performed by a processor is provided. The method may include receiving a plurality of text queries in a first natural language; and generating, by using a trained machine learning model, multi-channel routing predictions for the plurality of text queries in the first natural language. The trained machine learning model may have been trained by: translating a plurality of training text queries in a second natural language to the first natural language to generate a plurality of translated training text queries; retrieving contextual information corresponding to the plurality of training text queries; converting, using one or more multi-language embedding layers, the plurality of training text queries in the second natural language and the plurality of translated training text queries in the first natural language into embedding vectors; and training the machine learning model using the contextual information and the embedding vectors.

### BRIEF DESCRIPTION OF THE DRAWINGS

FIG. 1 shows an example of a system configured to implement a process for generating routing predictions for user inputs and contextual features, based on the principles disclosed herein.

FIG. 2 shows an example architecture for generating routing predictions, based on the principles disclosed herein.

FIG. 3 shows an example process of generating a training text corpus in multiple languages, based on the principles disclosed herein.

FIG. 4 shows an example machine learning model for generating routing predictions for text queries in multiple natural languages, based on the principles disclosed herein.

FIG. 5 shows a flowchart of an example method of training and deploying a machine learning model for routing prediction of a text query, based on the principles disclosed herein.

FIG. 6 shows a block diagram of an examples computing device 600 that may implement various features and processes, based on the principles disclosed herein.

### DETAILED DESCRIPTION OF SEVERAL EMBODIMENTS

In an example embodiment, a machine learning model may be trained using multi-language embedding layers. To generate an input for the multi-language embedding layers, a training text corpus in a source natural language (e.g., English) is be converted to another natural language (e.g., French). The training text corpus in both languages is then provided to the multi-language embedding layers. Contextual information associated with the training text corpus is provided as another training input to the machine learning model. The contextual information may include, for example, the time the training text was generated, geographical origin of the training text, to name a few. The machine learning model is trained using, e.g., backpropagation. After the training, the machine learning model generates routing predictions for text queries in the second natural language. Because the machine learning model can be trained for multiple languages-even when training text data is not available for some languages-the routing prediction from the trained machine learning model is language agnostic, not just confined to a single language.

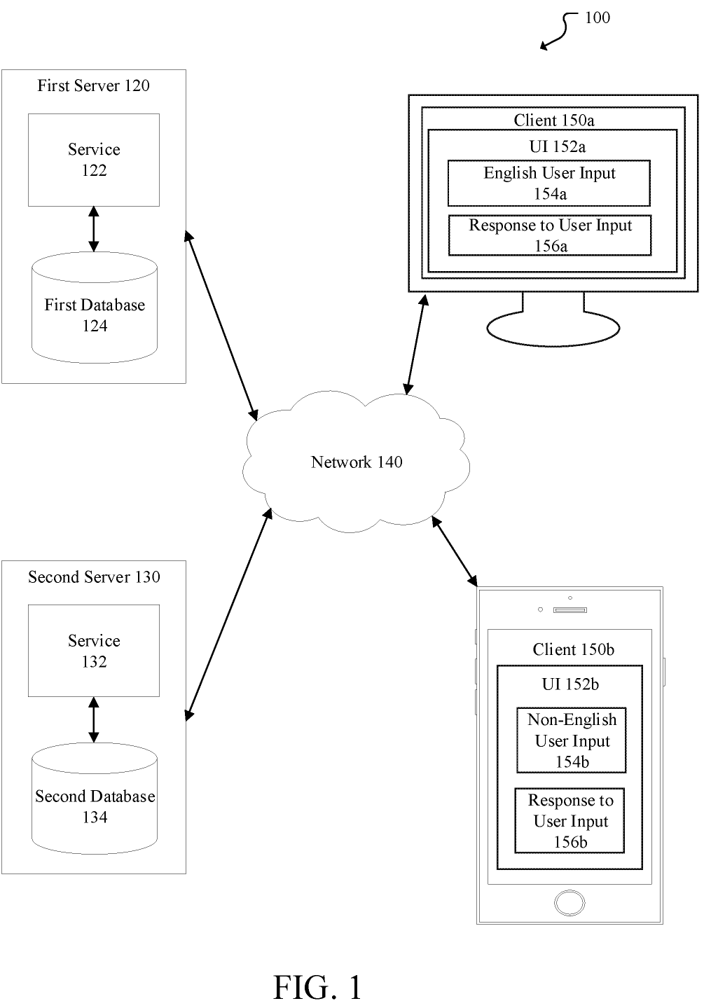

FIG. 1 shows an example of a system 100 configured to implement a process for generating routing predictions for one or more user inputs 154a, 154b (commonly referred to as user input 154 and collectively referred to as user inputs 154) and contextual features, based on the principles disclosed herein. The user inputs include, for example, questions and or search terms. As shown, a user input 154a is in English and another user input 154b is in a non-English language. The English and non-English dichotomy is just for an illustration, and any combination of languages should be considered within the scope of this disclosure. The routing predictions are based on the example trained machine learning models described throughout this disclosure.

The routing predictions include classifications or other outputs that predict-agnostic to the input language-user intent, the support group best equipped to handle the request included in the user input, the queue within the support group that receives the request, and the contact channel for connecting with the user. The intent predictions include a category, context, or other description of information the user is attempting to access via the user inputs 154 and or information required to resolve user requests, problems, and or issues included in the user inputs 154. For example, intent predictions include a classification that identifies the user inputs 154 as including product related requests, tax related requests, tax advice requests, and the like. The support group predictions and queue predictions determine a particular support group and sub-group of personnel within the support group that is best equipped to handle user requests having the predicted intent. Support group predictions and queue predictions are based on the complexity of the request included in the user input 154 and the proficiency and skill of the agents included in the support group and or subgroup assigned to the predicted queue. Channel predictions identify the contact medium (e.g., call, video chat, email, instant message, text message, and the like) for contacting the user to address the request included in the user inputs 154.

The system 100 includes a first server 120, second server 130, and client devices 150a and 150b (commonly referred to as a client device 150 and collectively referred to as client devices 150). First server 120, second server 130, and or client devices 150 are configured to communicate with one another through network 140. For example, communication between the elements is facilitated by one or more application programming interfaces (APIs). APIs of system 100 may be proprietary and or may include such APIs as Amazon^{®} Web Services (AWS) APIs or the like. Network 140 may be the Internet and/or other public or private networks or combinations thereof.

First server 120 is configured to implement a first service 122, which in one embodiment is used to generate features and or routing predictions from the user inputs 154 and or context (also referred to as contextual features or contextual information) associated with the user inputs 154. The user inputs 154 captured in the user interfaces (UI) 152a and 152b (commonly referred to as UI 152 and collectively referred to as Uls 152) of the client devices 150 are transferred to the first service 122 via the network 140 and stored in one or more databases 124, 134, the second server 130 and or client devices 150. In one or more embodiments, the first server 120 executes processes that extract one or more features (e.g., text features, context features, and the like) from the user inputs 154 and or associated context and generate an intent prediction for each piece of user input 154 based on the one or more features. In one or more embodiments, the first server 120 extracts one or more features and or generates the routing predictions using one or more machine learning models. The machine learning models are integrated with a business logic component to form a hybrid model that generates routing predictions based on an output from the machine learning models and business rules included in the business logic component. The hybrid model, the machine learning models, and the business logic component can be stored in the first database 124 or second database 134, and or received from second server 130 and or client devices 150.

First service 122 or second service 132 implement an information service, which includes a variety of products for managing data and providing functionalities to streamline workflows related to people, businesses, and other entities. The information service is any network 140 accessible service that maintains financial data, medical data, personal identification data, and or other data types. For example, the information service may include QuickBooks^{®} and its variants by Intuit® of Mountain View, California. The information service provide one or more features that use the structured form representations and structured metadata generated by the system 100. The information service can include a support platform that provides customer service to users of the information service.

The support platform consumes routing predictions and or contact type predictions generated by the first server 120 to enhance a user experience for one or more of the products included in the information service. For example, the support platform generates personalized answers in response to user questions based on the predicted intent and other routing predictions for each user request to provide a unique user experience. The personalized answers are provided as responses 156a and 156b (commonly referred to as response 156 and collectively referred to as responses 156) to the user inputs 154. The support platform also uses the contact type predictions to route user requests to a tax expert handling requests related to high complexity tax issues through video chats, a product support group handing requests related to one or more features of the information service through instant messaging, or other contact types that specialize in the type of issues related to the predicted intent for each request. The contact type predictions enable more efficient routing to agents to ensure users get better information about their specific issue in less time. The contact type predictions are also more detailed (e.g., contact types can route to a specific agent within a specific support group that connects with users through a particular channel) to account for user preferences, real time platform conditions (e.g., wait times, demand for certain support groups, performance of agents currently working, and the like), request complexity, and agent proficiency. These more detailed contact type predictions improve overall user experience and streamline the operation of the support platform.

Client devices 150 include any device configured to present user interfaces (Uls) 152 and receive user inputs 154. The Uls 152 are configured to display responses 156 the user inputs 154. The responses 156 include, for example, personalized answers, call queue confirmation, contact information of an appropriate subject matter expert, and or other outputs generated based on the routing predictions and or contact type predictions generated by the first server 120. The UIs 152 also capture session data including UI screen id, product id (e.g., product SKU), input text/product language, geography, platform type (e.g., online vs. mobile), and or other context features that are used to generate intent predictions. Exemplary client devices 150 include a smartphone, personal computer, tablet, laptop computer, or other device.

First server 120, second server 130, first database 124, second database 134, and client devices 150 are each depicted as single devices for ease of illustration, but those of ordinary skill in the art will appreciate that first server 120, second server 130, first database 124, second database 134, and or client devices 150 may be embodied in different forms for different implementations. For example, any or each of first server 120 and second server 130 may include a plurality of servers or one or more of the first database 124 and second database 134. Alternatively, the operations performed by any or each of first server 120 and second server 130 may be performed on fewer (e.g., one or two) servers. In another example, a plurality of client devices 150 may communicate with first server 120 and/or second server 130. A single user may have multiple client devices 150, and/or there may be multiple users each having their own client devices 150.

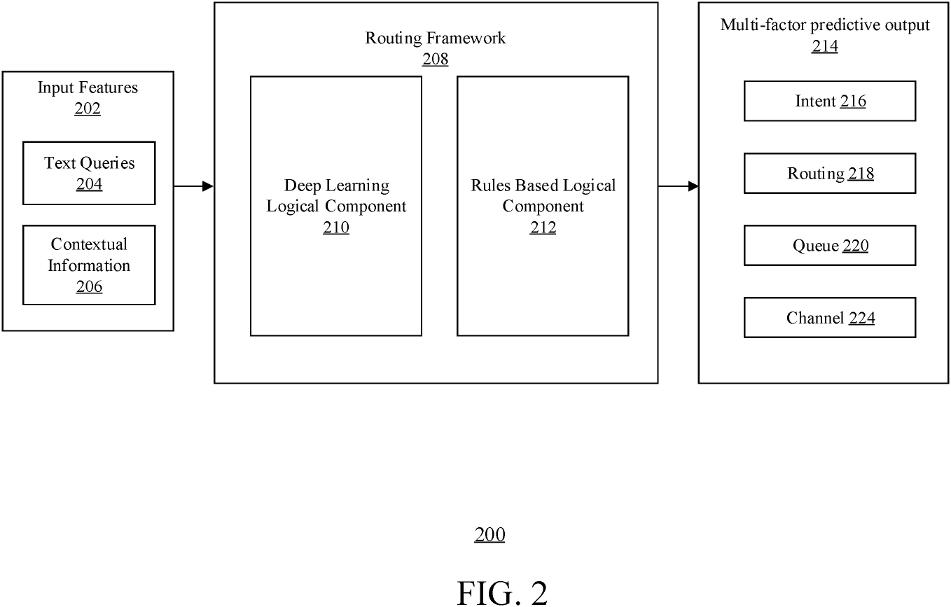

FIG. 2 shows an example architecture 200 for generating routing predictions, based on the principles disclosed herein. It should be understood that the architecture 200 and the constituent components are just for illustration and should not be considered limiting. Architectures with additional, alternative, and fewer number of components should also be considered within the scope of this disclosure. Within the architecture 200, a routing framework 208 receives the input features 202 containing text queries 204 and generates a multi-factor predictive output 214 for the text queries.

The text queries 204 typically comprise user questions entered into a user interface (e.g., user input 154a within user interface 152a as shown in FIG. 1). The user questions include, for example, questions about one or more services offered, and or diagnostic questions that have to be resolved for the user. In one or more embodiments, the text queries 204 are pre-processed for both training and deployment of a deep learning logical component 210 of the routing framework 208.

The preprocessing of the text queries includes cleaning up (e.g., removing extraneous tags) and standardizing the text (e.g., using standard spellings for the same concept). The cleaning up process includes removing tags such as html tags. The cleaning up process further includes replacing tokens. For instance, currency, url, and percentage tokens are replaced with <curr>, <link>, and <perc> tokens respectively. These types of tokens are replaced because the original tokens may not necessarily add value to the deep learning logical component 210 (i.e., they could instead make the vocabulary unnecessarily large).

Preprocessing also includes replacing acronyms in the text queries with their full forms. For instance, “CA” and “California” should be treated the same. A preprocessing vocabulary therefore is created for acronym mappings (e.g., having a mapping between “CA” and “California”). Additionally, strings are be converted to lowercase and punctuations are replaced with white spaces. Furthermore, “stop words” that occur frequently, but are generally unnecessary for the deep learning logical component 210 are removed. Some examples of stop words include “i,” “me,” and “and.”

Preprocessing further includes spell checking to ensure a consistent spelling for the same concepts that often use different words or forms. For instance, spellings are made consistent with the English vocabulary from Wikipedia (e.g., by using a spelling package). In addition to the general English vocabulary, one or more components of the architecture 200 maintains a specific corpus of words such as “turbotax, “covid,” which are generally application electronic tax preparation applications. As an example of consistency in spelling, each of “1099 int,” “1099INT,” “1099-InT,” etc. are converted to “1099-int.”

The contextual information 206 provides additional information about the text queries 204. In one or more embodiments, the contextual information 206 comprises temporal context features and user context features. Temporal context features are associated with the timing of the text queries 204. For instance, temporal context features include day of the week, time of the week, etc. associated with corresponding text queries 204. User context features include other features associated with the text queries 204, such as features extracted from session data of the text queries 204. The features extracted from the session data include, for example, product SKU, user account type, payment method, screen id, user id, product id, geography, language, platform type, and or any other type feature extracted from the session data. User context features are also extracted from user devices (e.g., smartphones, laptops, etc.) that the text queries 204 originate from. For instance, this type of user context features include language preferences, location of the device, device communication capabilities (e.g., whether the device is a smartphone that can receive calls and text messages or a laptop with a webcam that can receive video chats and instance messages), etc. Other examples of user context features include tax information such as entitlements, previous tax filings, current filing status, tax filing jurisdictions, and or any other type of tax information.

The contextual information 206 is generally numerical or categorical in nature and may not necessarily need extensive preprocessing. Some preprocessing, however, is performed such as removing rows with missing values and normalizing numerical features, to name a few

In one or more embodiments, the deep learning logical component 210 is trained using a corpus of input features 202. The training configures the deep learning logical component 210 to generate an output to be used by a rules based logical component 212 to generate a multi-factor predictive output 214 used to route the text queries 204 to an appropriate location. The rules based logical component 212 forms a deterministic part of the routing framework 208. Particularly, the rules based logical component 212 comprises predetermined business rules and or other ad hoc logic that modifies and or override the routing predictions generated by the deep learning logical component 210.

Using the predictions of the deep learning logical component 210 augmented by the rules based logical component 212, the routing framework 208 generates multi-factor predictive outputs 214 for the text queries 204. The multi-factor predictive output 214 comprises predictions of intent 214, routing 218, queue 220, and channel 224. The predicted intent 214 include a category, context, or other description of information a user is attempting to access via the corresponding text query 204 and or information required to resolve user requests, problems, and or issues included in the text query 204. For example, predicted intent 214 includes a classification that identifies the corresponding text query 204 as including product related requests, tax related requests, tax advice requests, etc. The predicted routing 218 includes a location or identification of the personnel that may be able address the issue in the corresponding text query 204. The predicted queue 220 includes an appropriate queue (e.g., associated with the personnel) that the request from the text query 204 may be put into. The predicted channel 224 identifies a contact medium (e.g., call, video chat, email, instant message, text message, and the like) for contacting the user to address the request included in the corresponding text query 204.

As described above, there is a desire for the deep learning logical component 210 to be able to handle text queries 204 in a language agnostic manner. The current corpus of training data, however, is mostly in English. As most of the text queries 204 have been in English, there has not been a cost effective way of training the deep learning logical component 210 for other languages in the past: the training data is sparse in the first place and if the deep learning logical component 210 is trained using the sparse data and additional data, the low usage of the routing framework 208 for non-English language queries may not justify the training cost.

Embodiments disclosed herein, however, are directed to training a deep learning model (e.g., the deep learning logical component 210) even when sparse training data is available. The use of machine translation between the languages and the use of multi-language embedding layers in accordance with the disclosed principles provide a cost-effective way of training a deep learning model to handle different languages.

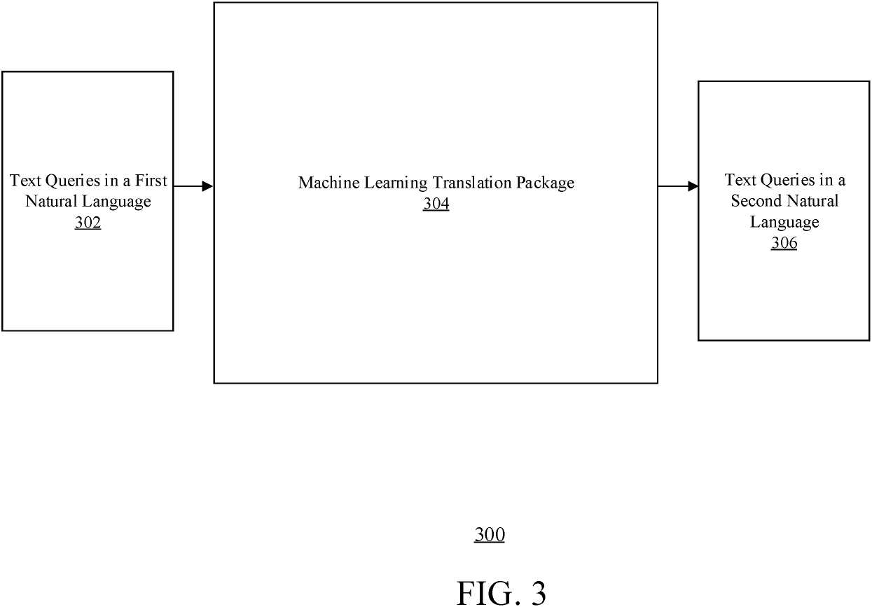

FIG. 3 shows an example process 300 of generating a training text corpus in multiple languages, based on the principles disclosed herein. Text queries in a first natural language (e.g., English) 302 are provided as inputs to a machine learning translation package 304. The machine learning translation package 304 generates the text queries in a second natural language 306 (e.g., French). Therefore, if the corpus of training data is low in the second natural language 306, the machine learning translation package 304 may be leveraged along with multi-language embedding layers to train a deep learning model to route text queries made in the second natural language despite this shortcoming

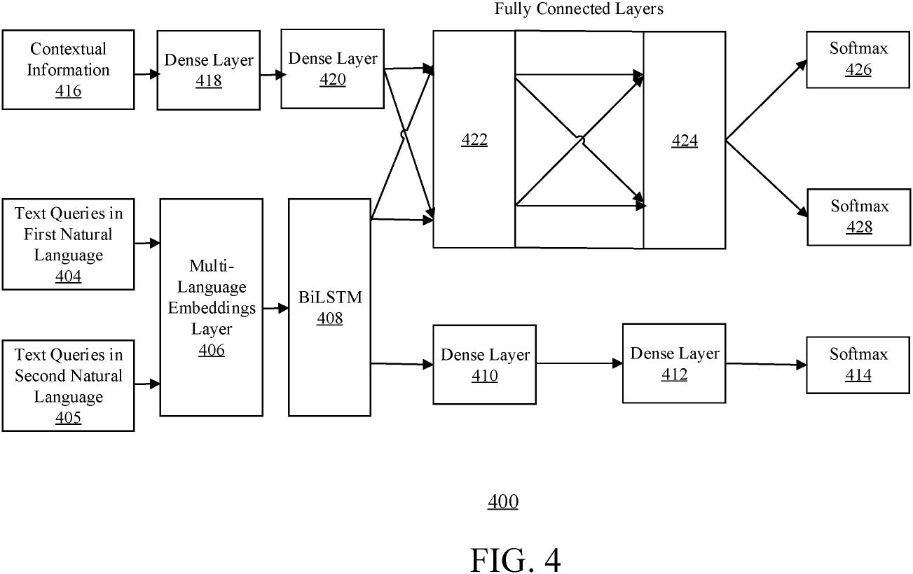

FIG. 4 shows an example machine learning model 400 for generating routing predictions for text queries in multiple natural languages, based on the principles disclosed herein. In one or more embodiments, the machine learning model 400 is used as the deep learning logical component 210 shown in FIG. 2.

During the training of the machine learning model 400, a multi-language embedding layer 406 receives text queries in a first natural language 404 and text queries in a second natural language 405. The text queries in the second natural language 405 are generated by machine translating the queries in the first natural language, e.g., by using the machine learning translation package 304 shown in FIG. 3. The multi-language embeddings layer 406 generates embedding vectors for the text queries in both the first natural language and the second natural language.

In some embodiments, the multi-language embedding layer 406 includes embedding layers of a BERT (Bidirectional Encode Representations from Transformers) model. BERT embedding layers are generally trained to discern intent/meaning from ambiguous words through bidirectional analysis (e.g., analyzing the text from both left to right and right to left). It should, however, be understood that the machine learning model 400 may not use all layers of the BERT model, but just its embeddings layers.

The multi-language embedding layer 406 generates numerical representations of tokenized words in the text queries 404 and 405. In one or more embodiments, the numerical representations are in the form of embedding vectors, which are generated using one or more statistical formulas, heuristics, algorithms, or other feature generation techniques. Within the embedding vectors space, each tokenized word is represented by a vector and the numerical relationship between the vectors is based on the relationship of the tokenized words in a sentence, paragraph, or entire text. For instance, embedding vectors numerically indicate that two words are likely to occur together. The multi-language embedding layer 406 is trained in multiple languages-and therefore the embedding vectors may be able to represent the same concept in different languages and further represent the relationship between the words or a group of words indicating the same concept.

The numerical representations of the tokenized words are provided to a Bidirectional long short-term memory (BiLSTM) layer 408, which extracts sentence-level meanings out of the embedding vectors generated by the previous layer 406. To extract the sentence level meanings, the BiLSTM layer 406 analyzes the embedding vectors from the usual left to right sequence (e.g., the usual reading and writing sequence of Indo-European languages) and also in the right to left sequence. This bidirectional analysis may detect additional nuances and meanings of the sentences compared to just a left to right sequence analysis.

The output from the BiLSTM layer 408 is fed through dense layers 410 and 412, and then to a softmax layer 414. The two dense layers 410 and 412 are shown as just examples, and any number of dense layers should be considered within the scope of this disclosure. Each neuron of the dense layers 410 and 412 is connected to all the neurons of its previous layer. The softmax layer 414 outputs a probability between 0 and 1 of one or more intents (e.g., intent 216 as shown in FIG. 2) from the text queries 404 and 405.

The contextual information 416 corresponding to the text queries 404 and 405 is fed to dense layers 418 and 420. Although two dense layers 418 and 420 are shown in the illustrated example, any number of dense layers should be considered within the scope of this disclosure. Each neuron of the dense layers 418 and 420 is connected to all the neurons of its previous layer. As shown in the illustrated example, the output of the dense layer is fed to fully connected layers 422 and 424 (two fully connected layers 422 and 424 are merely intended as examples and there may be additional layers between layers 422 and 424). In the fully connected layers 422 and 424, each neuron is connected to all neurons in a previous layer. Therefore, there may be no dropouts within the fully connected layers 422 and 424. The outputs of the fully connected layers 422 and 424 are fed to the softmax layers 426 and 428. Softmax layer 426 outputs a routing (e.g., predicted routing 218 shown in FIG. 2) and the softmax layer 428 outputs a channel (e.g., predicted channel 224 shown in FIG. 2).

The machine learning model 400 is trained using backpropagation techniques. More particularly, the inputs of the text queries in the first natural language 404, text queries in a second natural language 405, and the contextual information are provided to the machine learning model 400; and the prediction outputs of the softmax layers 426, 428, and 418 are compared against the expected corresponding outputs. The difference between the expected outputs and the actual outputs are backpropagated through the machine learning model to tune the different weights in the different layers, until the difference between the expected outputs and actual outputs are minimized below a threshold. In other words, the training is performed until the machine learning model can predict results in a desired level of accuracy.

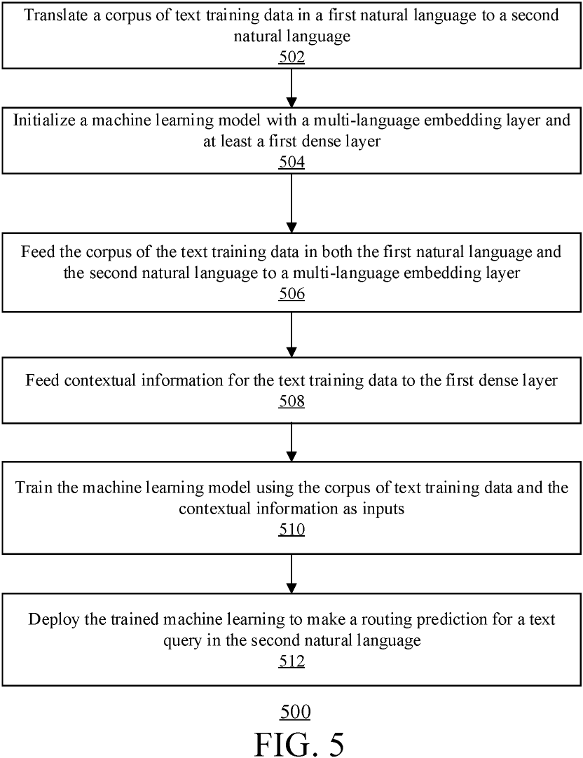

FIG. 5 shows a flowchart of an example method 500 of training and deploying a machine learning model for routing prediction of a text query, based on the principles disclosed herein. In particular, the machine learning model is trained using an available corpus of training text data (e.g., English) in a first natural language for a routing prediction of text queries in a second natural language (e.g., French).

At step 502, a corpus of training text data in a first natural language is translated to a second natural language. For instance, the majority of training text data may be in English and the training text data in another language, e.g., French, may be sparse. A machine learning model trained using the available corpus of training text data may therefore be confined to making predictions only for English-language text queries. To overcome this deficiency, a machine translation package is used to convert the training text data in the first natural language (e.g., English) to the second natural language (e.g., French).

At step 504, a machine learning model with a multi-language embedding layer and at least a first dense layer is initialized. The multi-language embedding layer receives training text data in multiple languages and generates embedding vectors therefrom. In some embodiments, the multi-language embedding layer uses the embedding layers from the BERT model. The first dense layer is adapted to receive contextual information for the training text data.

At step 506, the corpus of the training text data in both the first natural language and the second natural language are fed to the multi-language embedding layer. The multi-language embedding layer, which may be pretrained on both the first natural language and the second natural language, generates embedding vectors for the training text data.

At step 508, contextual information for the training text data is fed to the first dense layer. The contextual information includes additional features of the training text data. For instance, the contextual information for particular text is the time when the text was generated, the geographical origin of the text, user identification of the user who generated the text, the device where the text was generated, and or any other type of contextual information. The contextual information generally comprises categorical data (e.g., user id) and numerical data (time of text generation), and therefore may not have to be fed to an embedding layer.

At step 510, the machine learning model is trained using the corpus of the training text data (in both the first and second natural languages) and the contextual information as inputs. In particular, the outputs generated by the machine learning model are compared with expected outputs for the provided inputs. The difference between the expected outputs and the actual outputs are repeatedly backpropagated across the machine learning model until a desired level of accuracy is reached.

At step 512, the trained machine learning model is deployed to make a routing prediction for a text query in the second natural language. Because the machine learning model has been trained using the embedding layer that can handle the first and second natural languages, the trained machine learning model is able to make a prediction about a query in the second natural language.

It can therefore be understood that a machine learning model trained by method 500 does not necessarily need a corpus of training text data in the second natural language. This saves memory as the additional training text data is not required to implement the disclosed principles. Because of the multi-language layer at the beginning of the machine learning model, the corpus of the training text data may be in the first natural language, which is then machine translated into the second natural languages, and the corpus in both languages is used to train the model.

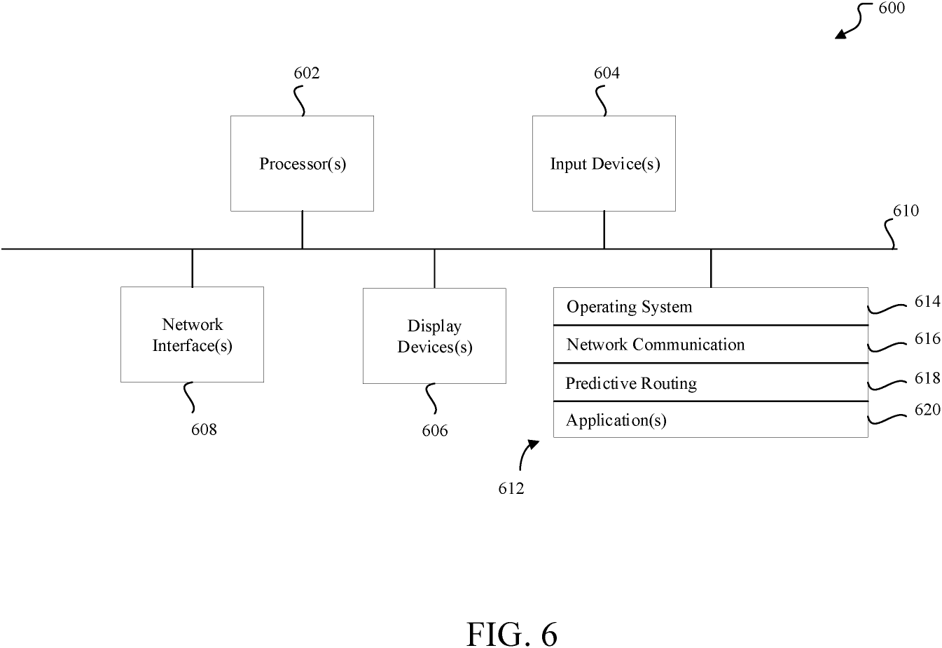

FIG. 6 shows a block diagram of an examples computing device 600 that implement various features and processes, based on the principles disclosed herein. For example, computing device 600 may function as first server 120, second server 130, client 150a, client 150b, or a portion or combination thereof in some embodiments. Additionally, the computing device 600 may partially or wholly form the architecture 200 and or wholly or partially host the machine learning translation package 304 and the machine learning model 400. The computing device 600 may also perform one or more steps of the method 500. The computing device 600 is implemented on any electronic device that runs software applications derived from compiled instructions, including without limitation personal computers, servers, smart phones, media players, electronic tablets, game consoles, email devices, etc. In some implementations, the computing device 600 includes one or more processors 602, one or more input devices 604, one or more display devices 606, one or more network interfaces 608, and one or more computer-readable media 612. Each of these components is be coupled by a bus 610.

Display device 606 includes any display technology, including but not limited to display devices using Liquid Crystal Display (LCD) or Light Emitting Diode (LED) technology. Processor(s) 602 uses any processor technology, including but not limited to graphics processors and multi-core processors. Input device 604 includes any known input device technology, including but not limited to a keyboard (including a virtual keyboard), mouse, track ball, and touch-sensitive pad or display. Bus 510 includes any internal or external bus technology, including but not limited to ISA, EISA, PCI, PCI Express, USB, Serial ATA or FireWire. Computer-readable medium 612 includes any non-transitory computer readable medium that provides instructions to processor(s) 602 for execution, including without limitation, non-volatile storage media (e.g., optical disks, magnetic disks, flash drives, etc.), or volatile media (e.g., SDRAM, ROM, etc.).

Computer-readable medium 612 includes various instructions 614 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 604; sending output to display device 606; keeping track of files and directories on computer-readable medium 612; controlling peripheral devices (e.g., disk drives, printers, etc.) which can be controlled directly or through an I/O controller; and managing traffic on bus 610. Network communications instructions 616 establish and maintain network connections (e.g., software for implementing communication protocols, such as TCP/IP, HTTP, Ethernet, telephony, etc.).

Predictive routing instructions 618 include instructions that implement the disclosed process for generating routing predictions to route customer service requests by using one or more machine learning models.

Application(s) 620 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant’s intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method performed by a processor, said method comprising:
translating a plurality of training text queries in a first natural language to a second natural language to generate a plurality of translated training text queries;
retrieving contextual information corresponding to the plurality of training text queries;
converting, using one or more multi-language embedding layers, the plurality of training text queries in the first natural language and the plurality of translated training text queries in the second natural language into embedding vectors; and
training a machine learning model using the contextual information and the embedding vectors, the trained machine learning adapted to be used for generating a multi-channel routing prediction from a test text query in the second natural language.

2. The method of claim 1, wherein training the machine learning model comprises repeatedly backpropagating corresponding differences between expected outputs and actual outputs.

3. The method of claim 2, wherein the actual outputs are generated by one or more softmax layers of the machine learning model during the training.

4. The method of claim 1, wherein training the machine learning model comprises training a bidirectional long short-term memory (BiLSTM) layer for extracting sentence level meanings from the embedding vectors.

5. The method of claim 1, wherein training the machine learning model comprises inputting the contextual information to a dense layer within the machine learning model.

6. The method of claim 1, wherein the one or more multi-language embedding layers comprise embedding layers from a bidirectional encode representations from transformers (BERT) model.

7. The method of claim 1, wherein the machine learning model comprises a deep learning model with one or more of dense layers, fully connected layers, and softmax layers.

8. A system comprising:
at least one processor; and
a computer readable non-transitory storage medium storing computer program instructions that when executed by the at least one processor cause the at least one processor to perform operations comprising:
translating a plurality of training text queries in a first natural language to a second natural language to generate a plurality of translated training text queries;
retrieving contextual information corresponding to the plurality of training text queries;
converting, using one or more multi-language embedding layers, the plurality of training text queries in the first natural language and the plurality of translated training text queries in the second natural language into embedding vectors; and
training a machine learning model using the contextual information and the embedding vectors, the trained machine learning adapted to be used for generating a multi-channel routing prediction from a test text query in the second natural language.

9. The system of claim 8, wherein the operation of training the machine learning model comprises repeatedly backpropagating corresponding differences between expected outputs and actual outputs.

10. The system of claim 9, wherein the actual outputs are generated by one or more softmax layers of the machine learning model during the training operation.

11. The system of claim 8, wherein the operation of training the machine learning model comprises training a bidirectional long short-term memory (BiLSTM) layer for extracting sentence level meanings from the embedding vectors.

12. The system of claim 8, wherein the operation of training the machine learning model comprises inputting the contextual information to a dense layer within the machine learning model.

13. The system of claim 8, wherein the one or more multi-language embedding layers comprise embedding layers from a bidirectional encode representations from transformers (BERT) model.

14. The system of claim 8, wherein the machine learning model comprises a deep learning model with one or more of dense layers, fully connected layers, and softmax layers.

15. A method performed by a processor, said method comprising:
receiving a plurality of text queries in a first natural language; and
generating, by using a trained machine learning model, multi-channel routing predictions for the plurality of text queries in the first natural language, the trained machine learning model having been trained by:
translating a plurality of training text queries in a second natural language to the first natural language to generate a plurality of translated training text queries;
retrieving contextual information corresponding to the plurality of training text queries;
converting, using one or more multi-language embedding layers, the plurality of training text queries in the second natural language and the plurality of translated training text queries in the first natural language into embedding vectors; and
training the machine learning model using the contextual information and the embedding vectors.

16. The method of claim 15, wherein the one or more multi-language embedding layers comprise embedding layers from a bidirectional encode representations from transformers (BERT) model.

17. The method of claim 15, wherein the machine learning model comprises a deep learning model with one or more of dense layers, fully connected layers, and softmax layers.

18. The method of claim 17, wherein the multi-channel routing predictions are generated by the softmax layers.

19. The method of claim 15, wherein machine learning model comprises a bidirectional long short-term memory (BiLSTM) layer for extracting sentence level meanings from the embedding vectors.

20. The method of claim 15, the machine learning model having been trained using backpropagation.
